(19) United States
(12) Patent Application Publication
(10) Pub. No.: US 2017/0070668 A1
(43) Pub. Date: Mar. 9, 2017

(54) ELECTRONIC DEVICES FOR CAPTURING IMAGES

(71) Applicant: Fortemedia, Inc., Santa Clara, CA (US)

(72) Inventors: Jim BOHAC, Santa Clara, CA (US); Lan-Ping DENG, Santa Clara, CA (US)

(21) Appl. No.: 15/252,598

(22) Filed: Aug. 31, 2016

Related U.S. Application Data
(60) Provisional application No. 62/215,861, filed on Sep. 9, 2015.

(51) Int. Cl. H04N 5/232; H04N 5/225; G06K 9/00

(52) U.S. Cl. CPC H04N 5/23219; G06K 9/00228; H04N 5/23264; H04N 5/2252; H04N 5/23296

(57) ABSTRACT

An electronic device is provided. The electronic device includes housing, a camera, a display, at least two sound detectors, and a control circuit. The camera has a camera lens and camera circuitry. The camera lens is disposed on the housing. The display is disposed on the housing. The sound detectors are spaced apart and disposed at two different locations of the housing. The sound detectors are configured to detect an audible sound and transform the detected sound into electrical signals. The control circuit receives the electronic signals. The control circuit is configured to determine a relative direction of a location of the detected sound and generate a first control signal according to the determined direction.

### CROSS REFERENCE TO RELATED APPLICATIONS

This application claims the benefit of U.S. Provisional Application No. 62/215,861, filed on Sep. 9, 2015, the contents of which are incorporated herein by reference.

### BACKGROUND OF THE INVENTION

Field of the Invention

The invention generally relates to portable electronic devices, and more particularly to portable electronic devices for capturing images.

Description of the Related Art

In recent years, it has become quite popular for users to use portable cameras for taking pictures of themselves (known as “selfies”) While a user is taking selfies, the user has to hold an image-capturing device with a hand or selfie stick, guide the image-capturing device to face the user by moving the arm, and take a selfie by touching a camera button or screen with the finger. However, the muscle movement of the user may shake the image-capturing device easily. The image-capturing device may also be out of focus or take pictures in wrong direction (e.g. where the user is not centered in the frame), which results in off-centered, blurred, or unclear pictures.

It is desired to provide devices with the ability to accommodate selfie photographs with improved results.

### BRIEF SUMMARY OF THE INVENTION

An exemplary embodiment of an electronic device is provided. The electronic device comprises housing, a camera, a display, at least two sound detectors, and a control circuit. The camera has a camera lens and camera circuitry. The camera lens is disposed on the housing. The display is disposed on the housing. The sound detectors are spaced apart and disposed at two different locations of the housing. The sound detectors are configured to detect an audible sound and transform the detected sound into electrical signals. The control circuit receives the electronic signals. The control circuit is configured to determine a relative direction of a location of the detected sound and generate a first control signal according to the determined direction.

Another exemplary embodiment of an electronic device is provided. The electronic device comprises a housing, a camera, a display, at least two sound detectors, and a control circuit. The camera has a camera lens and camera circuitry. The camera lens is disposed in the housing. The display is disposed in the housing. The sound detectors are spaced apart and disposed at two different locations of the housing. The sound detectors are configured to detect an audible sound and transform the detected sound into electrical signals. The control circuit receives the electronic signals. The control circuit is configured to determine a relative direction of a location of the detected sound and generate a control signal according to the determined direction. The camera circuitry pans the camera lens according to the control signal.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a top-view of appearance of an electronic device in accordance with an embodiment;

FIG. 1B is a back-view of appearance of an electronic device in accordance with an embodiment;

FIG. 1C is a front-view of appearance of an electronic device in accordance with an embodiment;

FIGS. 2A-2D are schematic views showing various locations in accordance with embodiments;

FIG. 3A is a top-view of appearance of an electronic device in accordance with another embodiment;

FIG. 3B is a front-view of appearance of an electronic device in accordance with another embodiment;

FIGS. 4A-4D are schematic views showing various locations in accordance with embodiments;

FIG. 5 shows an exemplary of an electronic device;

FIG. 6 is a schematic view showing a sound source emitting a sound to an electronic device in accordance with an embodiment;

FIG. 7 shows another exemplary of an electronic device;

FIG. 8 is a schematic view showing a relative direction of a sound source to an electronic device in accordance with an embodiment;

FIGS. 9A and 9B are schematic views showing variation of an angle of view of a camera lens of an electronic device in accordance with an embodiment;

FIG. 10 is a schematic view showing a window corresponding to a sound source in a sensing array of an electronic device in accordance with an embodiment;

FIG.11 shows another exemplary of an electronic device;

FIG. 12 shows another exemplary of an electronic device;

FIG. 13 shows another exemplary of an electronic device;

FIG. 14 shows another exemplary of an electronic device; and

FIGS. 15A and 15B are schematic views showing that a sound source whose direction of the location does not align with a camera lens with in accordance with an embodiment.

### DETAILED DESCRIPTION OF THE INVENTION

The following description is of contemplated modes and implementations for carrying out the invention. This description is made for the purpose of illustrating the general principles of the invention and should not be taken in a limiting sense. The scope of the invention is best determined by reference to the appended claims.

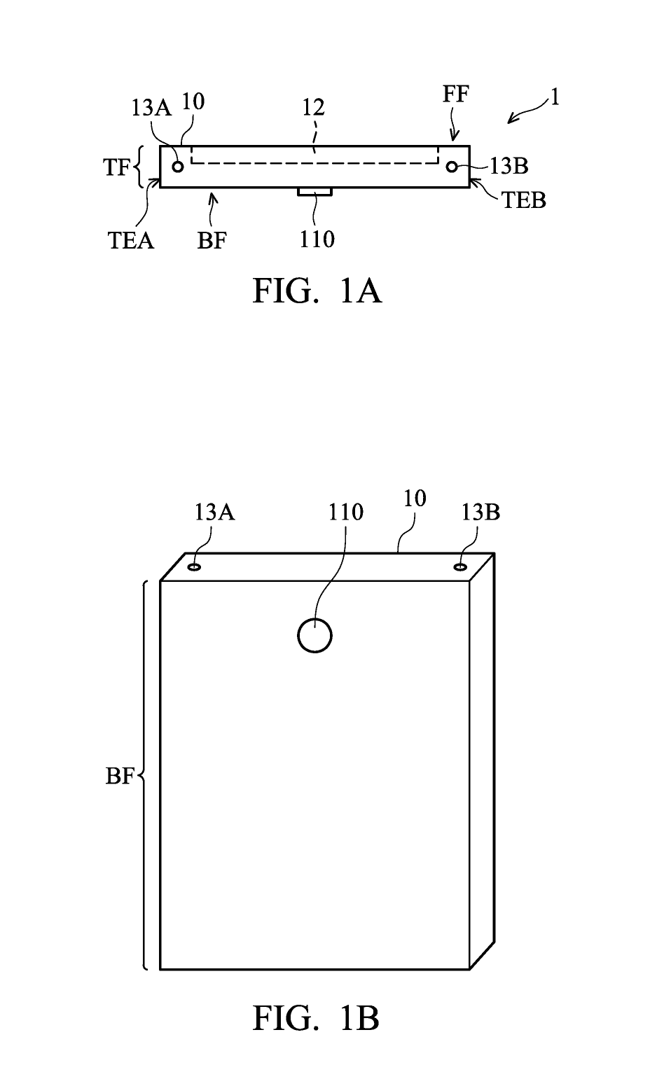

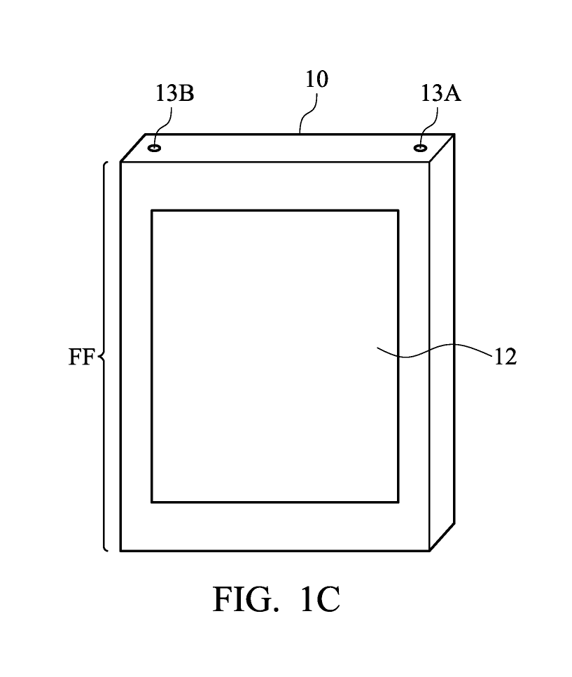

FIG. 1A is a top-view of appearance of an electronic device in accordance with an embodiment. Referring to FIG. 1A, the electronic device 1 comprises a housing 10, a camera lens 110 of a camera, a display 12, and at least two sound detectors. The at least two sound detectors are disposed at different locations of the housing 10. In the embodiment of FIG. 1A, two sound detectors 13A-13B (e.g., microphone elements) are taken as an example for illustration (but additional sound detectors may be utilized—e.g., 3 sound detectors). The sound detectors 13A and 13B are spaced apart and disposed on different locations on the top face TF of the housing 10. Referring to FIG. 1A, the sound detectors 13A and 13B are disposed at locations close to the two different edges TEA and TEB of the top face TF, respectively. The camera lens 110 is disposed one side of the housing 10, and the display 12 is disposed on another side. For example, as shown in FIGS. 1B and 1C, the camera lens 110 is disposed on the back face BF of the housing 10, while the display 12 is disposed on the front face FF thereof opposite the camera lens 110. In the embodiment of FIGS. 1A-1C, the camera lens 110 is a lens of a back camera of the electronic device 1.

In operation, the sound detectors 13A and 13B are used, in conjunction with control circuitry, to determine a relative direction of sound, and that determined direction is used to help center the user in the frame of a picture. For example, when using the device to take a selfie, the user may speak or make some other sound. As the sound emanates from the user's mouth (e.g., a central point of the user's face, by determining the direction of that sound), the device can use that determined direction to help center the user's face in the frame. As will be described herein, this centering operation can be performed in one several ways. In one embodiment (e.g., an embodiment where the camera lens 110 is movable), the control circuitry of the device can cause the camera lens 110 to move toward the determined direction of the sound. In another embodiment (e.g., an embodiment where the camera lens 110 is a stationary lens), the control circuitry of the device can implement a digital pan operation (e.g., if the device utilizes a CCD, the picture frame may be defined within an array subset of the CCD, and that array subset may be repositioned in the determined direction). In yet other embodiments, audible or visual feedback may be provided to prompt the user to tilt or pan the device in a direction toward the determined direction. For example, the device may emit an audible tone, and the frequency of that tone may change (e.g., increase) as the direction of the device is determined to more closely align with the determined direction of the emanating sound.

It will be appreciated that at least two sound detectors 13A and 13B are desired in order to implement this functionality. Preferably three or more sound detectors will be utilized, in order to better triangulate the direction of the emanated sound.

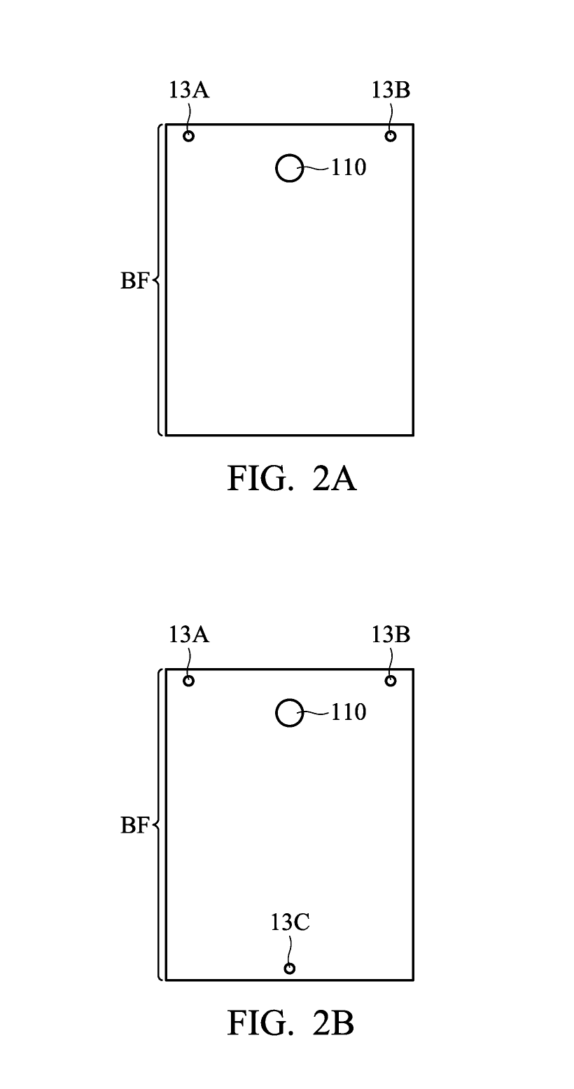

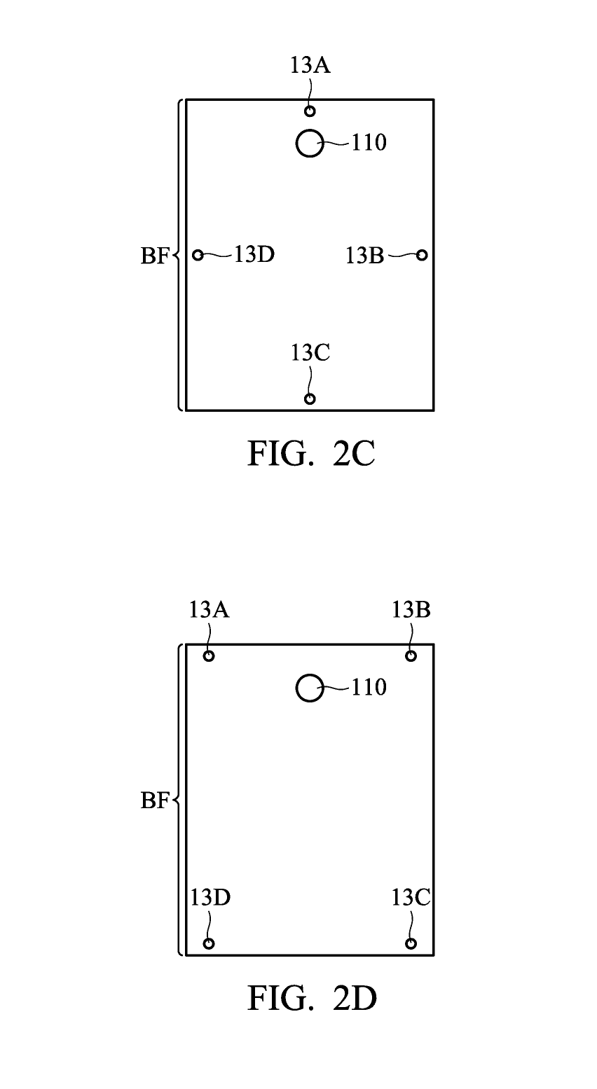

According to other embodiments, the sound detectors may be disposed on the back face BF of the housing 10, where the camera lens 110 is disposed, instead of the top face TF shown in the embodiment of FIGS. 1A-1C. As shown in FIG. 2A, the sound detectors 13A and 13B are disposed at two different locations on the back face BF, such as two different corners of the back face BF. In another embodiment, the electronic device 1 may comprise three sound detectors 13A-13C. As shown in FIG. 2B, two of the three sound detectors 13A-13C are disposed on two different corners of the back face BF respectively, and the third one is disposed on the lower edge of the back face BF. In other embodiments, the electronic device 1 may comprise four sound detectors 13A-13D. As shown in FIG. 2C, the sound detectors 13A-13D are disposed on different edges of the back face BF respectively, or, as shown in FIG. 2D, the sound detectors 13A-13D are disposed on different corners of the back face BF respectively.

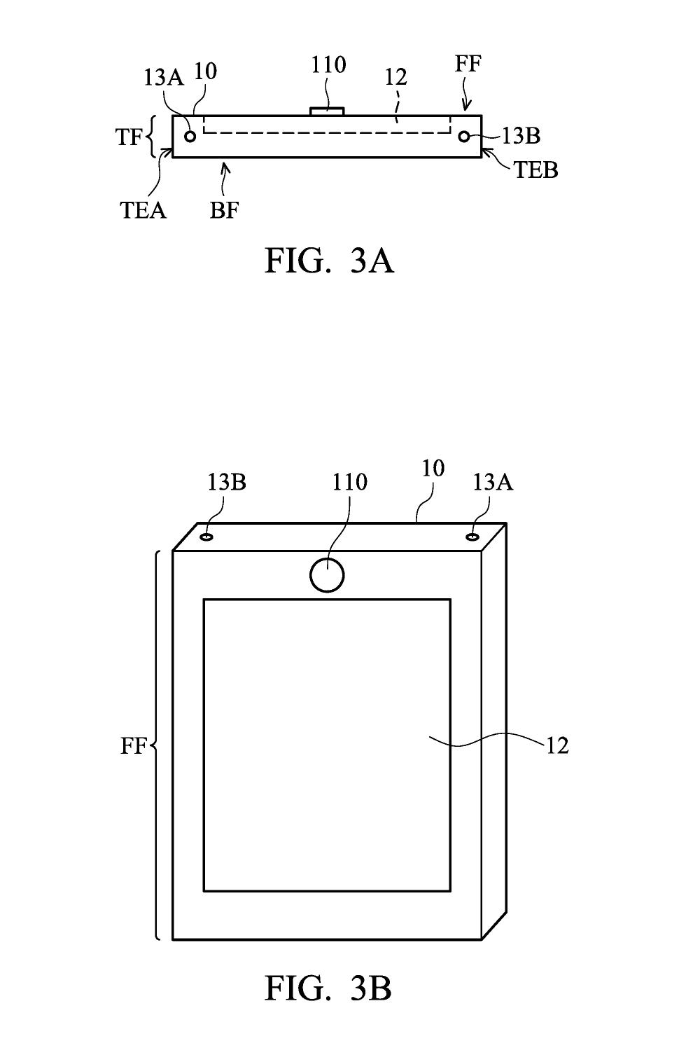

In the above embodiments, the camera lens 110 and the display 12 are disposed to different sides of the housing 10. According to other embodiments, the camera lens 110 and the display 12 may be disposed on the same side of the housing 10. For example, referring to FIGS. 3A and 3B, both of the camera lens 110 and the display 12 are disposed on the front face FF of the housing 10, and the sound detectors 13A and 13B are disposed on the top face TF of the housing 10. In this case, the camera lens 110 is a lens of a front camera of the electronic device 1.

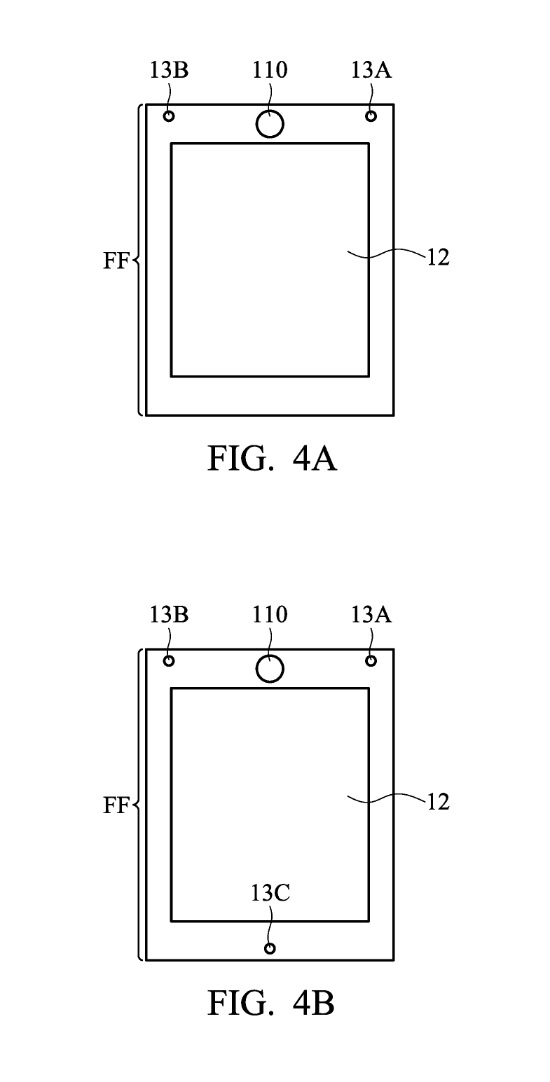

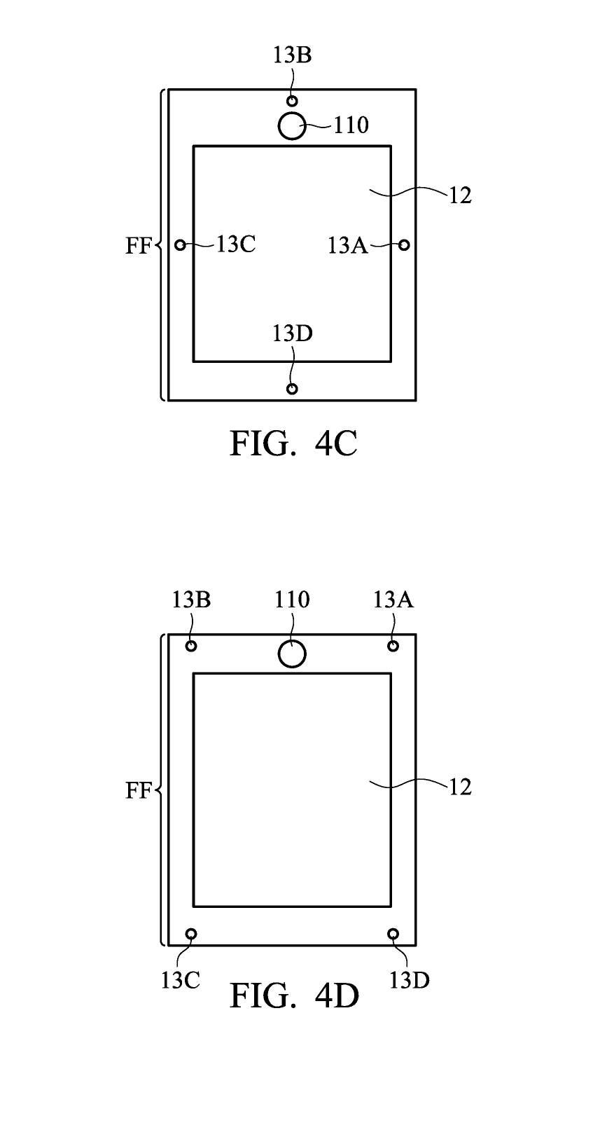

According to other embodiments, in the case where both of the camera lens 110 and the display 12 are disposed on the front face FF, the sound detectors may be disposed on the front face FF of the housing 10, where the camera lens 110 is disposed, instead of the top face TF shown in the embodiment of FIGS. 3A-3B. As shown in FIG. 4A, when the electronic device 1 may comprise two sound detectors, for example sound detectors 13A and 13B and 13B, the sound detectors 13A and 13B are disposed at two different locations on the front face FF, such as two different corners of the front face FF. In another embodiment, the electronic device 1 may comprise three sound detectors 13A-13C. As shown in FIG. 4B, two of the sound detectors 13A-13C are disposed on two different corners of the front face FF respectively, and the third one is disposed on the lower edge of the front face FF. In other embodiments, the electronic device 1 may comprise four sound detectors 13A-13D. As shown in FIG. 4C, the sound detectors 13A-13D are disposed on different edges of the front face FF respectively, or, as shown in FIG. 4D, the sound detectors 13A-13D are disposed on different corners of the front face BF respectively.

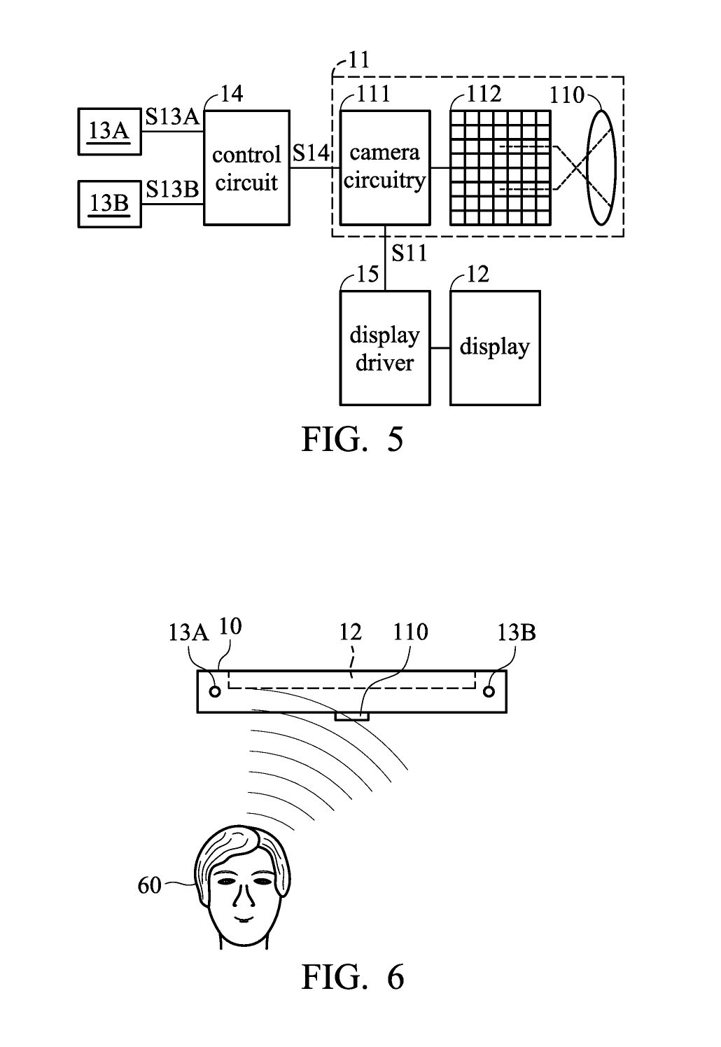

In addition to the housing 10, the camera lens 110, the display 12, and the sound detectors observed from the appearance of the electronic device 1, the electronic device 1 further comprises a camera 11, a control circuit 14, and a display driver 15, as shown in FIG. 5. The camera 11 comprises the lens 110, a camera circuitry 111, and a sensor array 112. The sensor array 112 can be a charge coupled device (CCD) array or a complementary metal oxide semiconductor (CMOS) array. In the embodiment of FIG. 5, two sound detectors 13A and 13B, which are disposed on the edges TEA and TEB of the top face TF respectively shown in FIGS. 1A-1C, are taken as an example for illustrating the operation of the electronic device 1. The sound detectors 13A and 13B are configured to detect audible sounds. When detecting an audible sound, the sound detectors 13A and 13B transform the detected sound into electrical signals S13A and S13B respectively. The control circuit 14 receives the electrical signals S13A and S13B to determine the relative direction of the location of the detected sound.

Referring to FIG. 6, a sound source 60, for example a user of the electronic device 1, emits an audible sound. Since the sound detector 13A is closer to the sound source 60 than the sound detector 13B, the time when the sound reaches the sound detector 13A is shorter than the time when the sound reaches the sound detector 13B, and the sound volume detected by the sound detector 13A is greater than the sound volume detected by the sound detector 13B. Accordingly, the electronic signals S13A and S13B have different features, such as different waveforms or signal powers. The control circuit 14 is capable of determining the relative direction of the location of the sound source 60 according to the electronic signals S13A and S13B with the different features. In an embodiment, the control circuit 14 performs a direction-of-arrival (DOA) estimation operation on the electric signals S13A and S13B to determine the direction of the location of the sound source 60. According to the determined direction, the control circuit 14 generates a control signal S14.

The control signal S14 may be used for different purposes in different embodiments. In certain embodiments, the control signal S14 is used to cause a physical pan or zoom operation of the camera lens. In other embodiments, the control signal S14 may be used to cause or implement a digital pan or zoom operation. In other embodiments, the control signal S14 may be used to trigger or provide feedback (e.g., audible or visible) signals to the user, to direct the user to guide the direction of the device.

The camera circuitry 111 of the camera 11 receives the control signal S14 and controls the camera 11 according to the control signal S14 to capture an image of the sound source 60 through the lens 110 and the sensor array 112. Then, the camera circuitry 111 generates an image signal Si 1 for the display driver 15 according to voltages or charges derived from the sensor array 112. The display driver 15 drives the display 12 according to the image signal S11 to show a picture of the sound source 60.

The following describes how the camera 11 captures the image of the sound source 60 according to the control signal S14 will be described in several different embodiments.

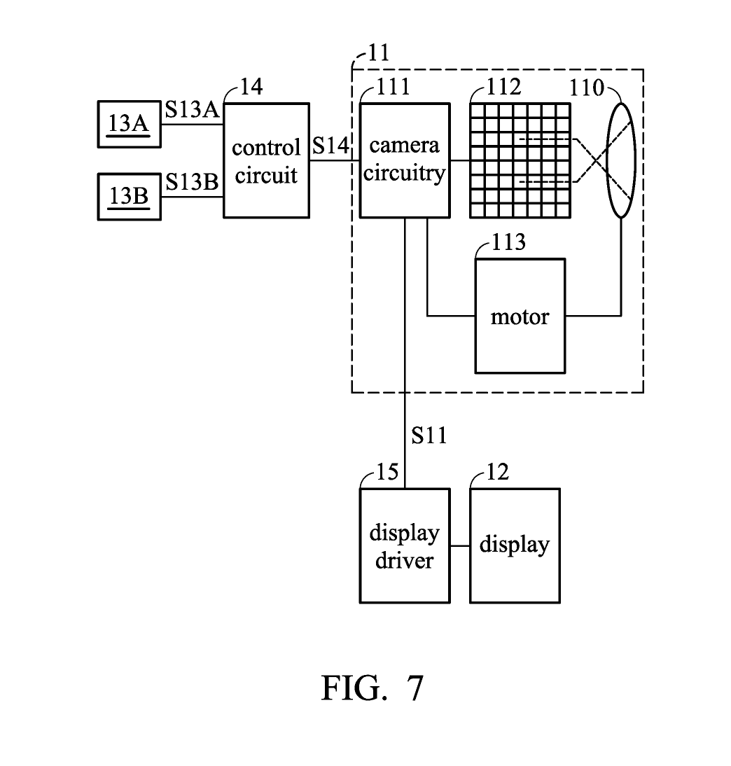

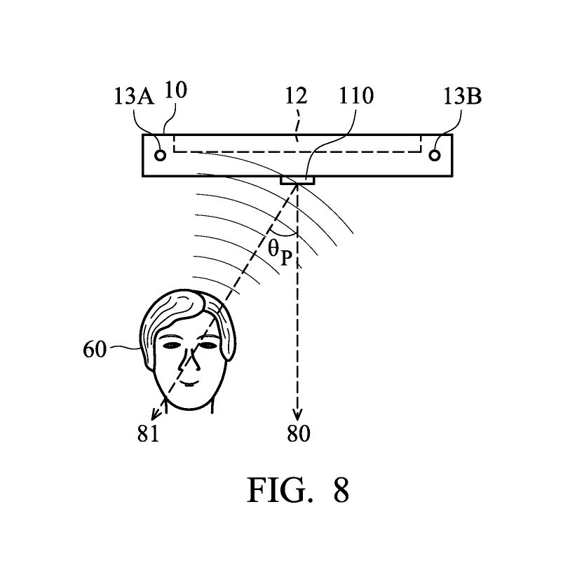

According to an embodiment, as shown in FIG. 7, the camera 11 further comprises a motor 113 which is controlled by the camera circuitry 111. As described above, since the control signal S14 is generated according to the result of the direction determination, the camera circuitry 111 can obtain the direction of the location of the sound source 60 according to the control signal S14. The camera circuitry 111 determines whether the camera lens 110 faces the direction of the location of the sound source 60. When the camera circuitry 111 determines that a central axis of the camera lens 110 does not align with the direction of the location of the sound source 60, the camera circuitry 111 determines a panning angle and controls the motor 113 to physical pan the camera lens 110 through the panning angle to more closely align with the determined direction of the sound source. For example, as shown in FIG. 8, the camera lens 110 initially faces the direction 80, and the sound source 60 is disposed in the direction 81. The camera circuitry 111 determines a panning angle θ_{P}, which is equal to the difference between the directions 80 and 81, according to the control signal S14 and controls the motor 113 to physical pan the lens 110 through the determined panning angle θ_{P}. After the camera lens 110 is physical panned toward the direction of the location of the sound source to face the sound source 60, the camera 11 captures the image of the sound source 60 through the lens 110 and the sensor array 112.

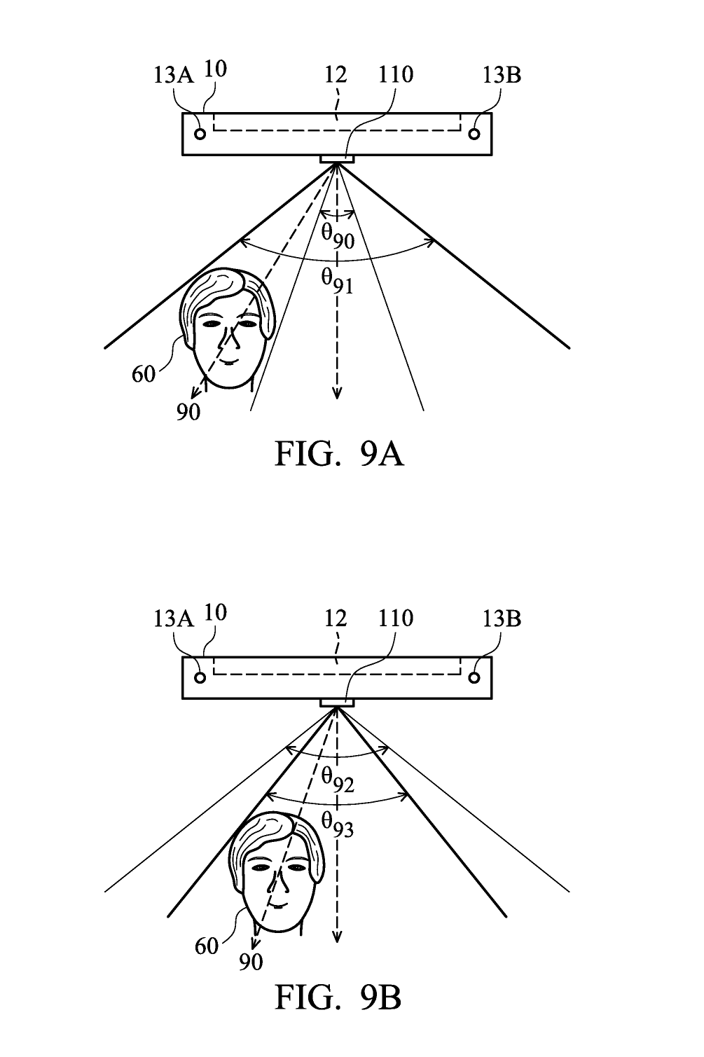

According to some embodiments, the control signal S14 related to the determined detection is applied for zoom adjustment of the camera lens 110. In an embodiment, the camera lens 110 is a zoom lens with variable focal length. When the focal length of the camera lens 110 is longer, the angle of view thereof is narrower; conversely, when the focal length of the camera lens 110 is shorter, the angle of view thereof is winder. As described above, since the control signal S14 is generated according to the result of the direction determination, the camera circuitry 111 can obtain the direction of the location of the sound source 60 according to the control signal S14. The camera circuitry 111 determines whether the direction of the location of the sound source 60 is in the current angle of view of the camera lens 110 to physically zoom in or out the camera lens 110. As shown in FIG. 9A, when the camera circuitry 111 determines that the direction 90 of the location of the sound source 60 is not in the current angle θ₉₀ of view of the camera lens 110, the camera circuitry 111 physically zooms out and re-focuses the camera lens 110. Thus, the camera lens 110 has a shorter focal length and a winder angle θ₉₁ of view, such that the direction 90 of the location of the sound source 60 is in the angle θ₉₁ of view. After the adjustment of the angle of view, the camera 11 captures the image of the sound source 60 through the lens 110 and the sensor array 112 by using the angle θ₉₁ of view. Since the winder angle θ₉₁ of view is applied, the appearance of the sound source 60 can be included in the captured image. In another case, as shown in FIG. 9B, when the camera circuitry 111 determines that the direction 91 of the location of the sound source 60 is in the current angle θ₉₂ of view of the camera lens 110, the camera circuitry 111 physically zooms in and re-focuses the camera lens 110. Thus, the camera lens 110 has a longer focal length and a narrower angle θ₉₃ of view, but the direction 90 of the location of the sound source 60 is still in the angle θ₉₃ of view. After the adjustment of the angle of view, the camera 11 captures the image of the sound source 60 through the lens 110 and the sensor array 112 by using the angle θ₉₃ of view. Due to the zoom-in, the appearance of the sound source 60 on the captured image can be more clear or larger.

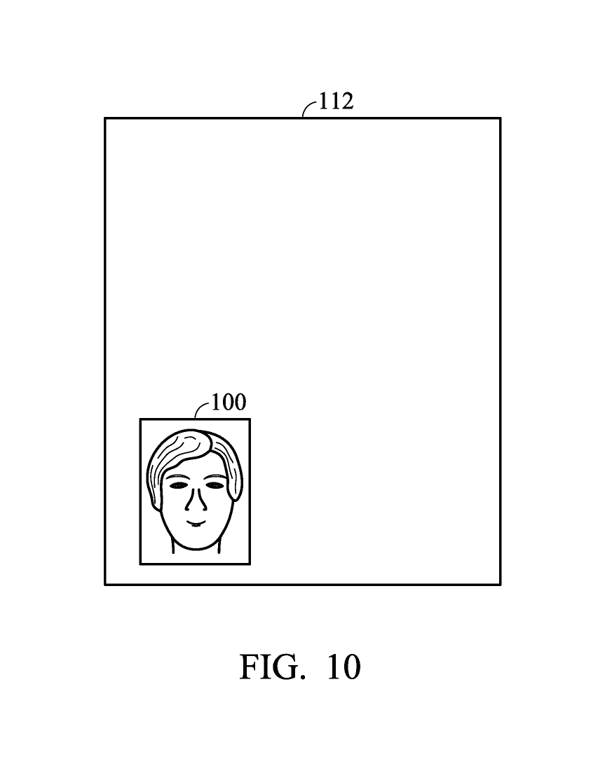

In an embodiment, the camera lens 110 may be a fixed focal length (FFL) lens. Since the control signal S14 is generated according to the result of the direction determination, the camera circuitry 111 can obtain which portion of the sensor array 112 corresponds to the direction of the location of the sound source 60 according to the control signal S14. For example, as shown in FIG. 10, a window 100 of the sensor array 112 corresponds to the direction of the location of the sound source 60. The camera circuitry 111 reads voltages or charges derived from the pixels in the window 100 to obtain a corresponding sensing signal. Then, the camera circuitry 111 can perform a digital zoom or digital pan operation (operations which are understood by persons skilled in the art) on the sensing signal to generate the image signal S11. When the camera circuitry 111 performs the digital zoom operation, the size of the picture of the sound source 60 shown in the display 12 is enlarged or reduced. That is, the digital operation causes the camera circuitry 111 to zoom in or out toward the direction of the location of the sound source 60.

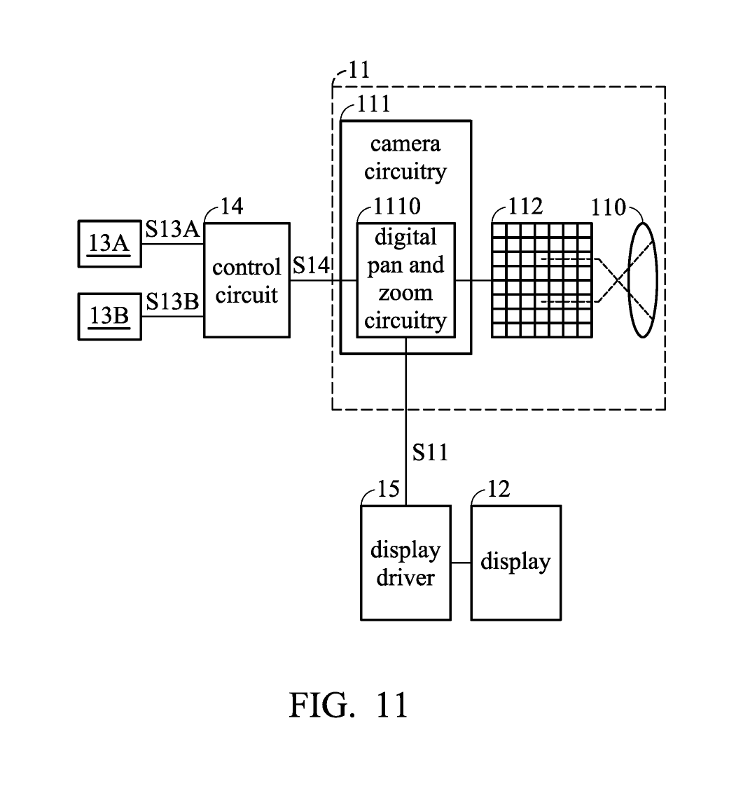

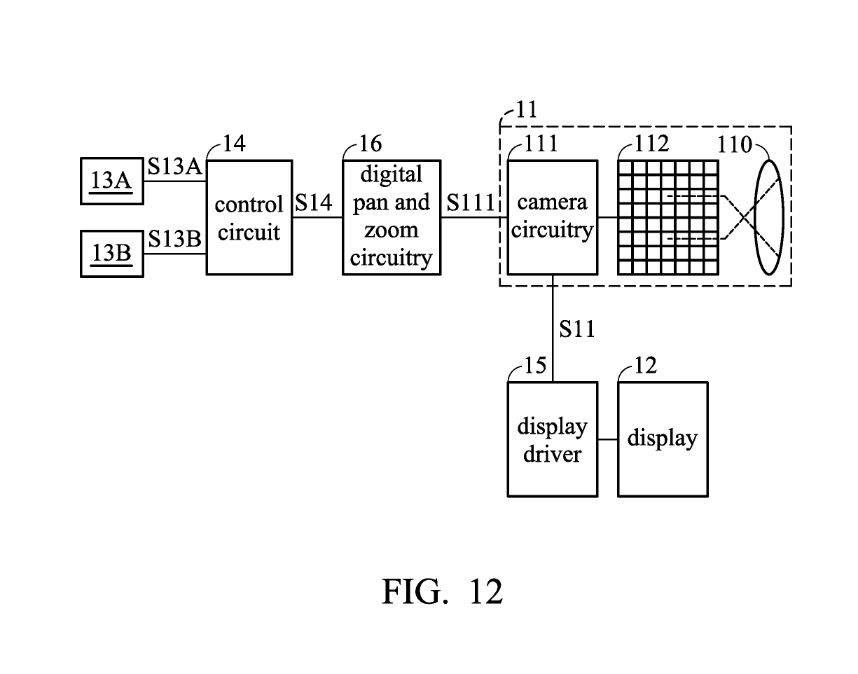

When the camera circuitry 111 performs the digital pan operation, the picture of sound source 60 can be shown in any portion of the display 12. For example, the window 100 corresponding to the direction of the location of the sound source 60 is at the lower left corner of the sensor array 112. Through the digital pan operation, the picture of the sound source 60 can be shown on any portion of the display 12, such as the center portion of the display 12. Thus, the digital pan operation causes the camera circuitry 111 to pan toward the direction of the location of the sound source 60. In the embodiment, the camera circuitry 111 comprises a digital pan and zoom circuitry 1110, as shown in FIG. 11. The digital pan and zoom circuitry 1110 receives the control signal S14 and performs the above digital zoom or digital pan operation on the sensing signal according to the control signal S14. In another embodiment, the electronic device 1 further comprises a digital pan and zoom circuitry 16 which is independent from the camera 11, as shown in FIG. 12. The digital pan and zoom circuitry 16 receives the control signal S14. The digital pan and zoom circuitry 16 receives the sensing signal S111 corresponding to the window 100 and performs the above digital zoom or digital pan operation on the sensing signal S111 according to the control signal S14 to generate an image signal S16. Then, the display driver 15 drives the display 12 according to the image signal S16 to show a picture of the sound source 60.

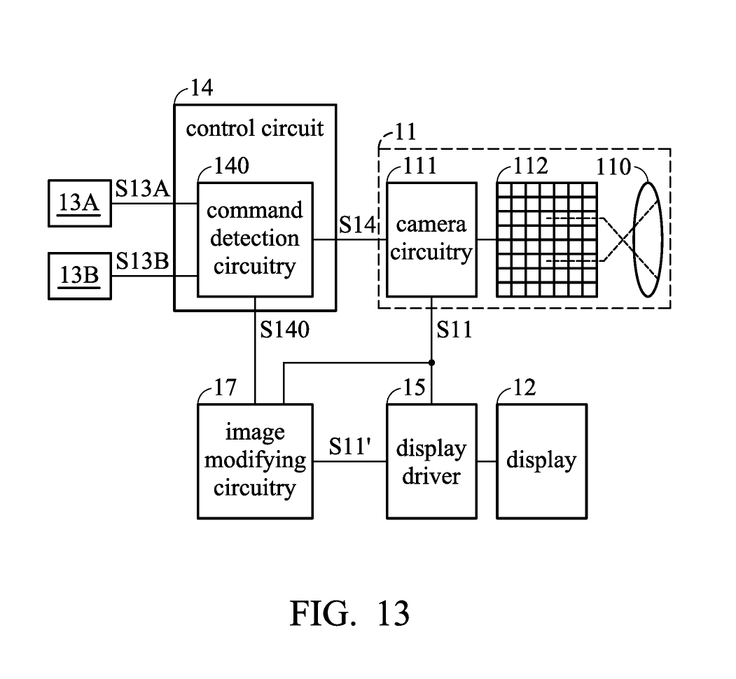

According to other embodiments, the zoom or pan of the camera 11 can be controlled by the detected sounds with different tones or spectrums. Referring to FIG. 13, the control circuit 14 further comprises a command detection circuitry 140. The command detection circuitry 140 receives the electrical signals S13A and S13B and determines the relative direction of the location of the sound source 60 according to the electronic signals S13A and S13B. After the direction of the location of the sound source 60 is determined, the command detection circuitry 140 determines whether the detected sound from determined direction matches a predetermine command by analyzing the feature of the detected sound, such as the tone or spectrum. In the embodiment, the predetermine command is related to a physical or digital zoom operation, a physical or digital pan operation, or an image modifying operation, such as “zoom to 10% (20%, 30%, . . . or 100%)”, “move to the left (right, up, or bottom)”, or “add effect of Tint (Cartoon, or Fisheye)”. For example, when the detected sound from determined direction matches “zoom to 10%”, the command detection circuitry 140 generates the control signal S14 to the camera 11, and the camera 11 or the digital pan and zoom circuitry 16 performs a physical or digital zoom operation to enlarge the picture of the sound source 60 by 10%. When the detected sound from determined direction matches the predetermined command related to a physical or digital pan operation, for example, “move to the left”, the command detection circuitry 140 generates the control signal S14 to the camera 11, and the camera 11 or the digital pan and zoom circuitry 16 performs a physical or digital pan operation to pan the camera 11 toward the determined direction by the left direction for showing the picture of the sound source 60 on the specific portion of the display 12. Referring to FIG. 13, the electronic device 1 further comprises an image modifying circuitry 17 which receives the image signal S11. When the detected sound from determined direction matches the predetermined command related to an image modifying operation, for example, “add effect of Tint”, the command detection circuitry 140 generates a control signal S140 to the camera 11, and the image modifying circuitry 17 modifies the image signal S11 by adding the effect of Tint according to the control signal S140. The image modifying circuitry 17 provides the image signal S11′ to the display driver 15. Then, the display driver 15 drives the display 12 according to the image signal S11′ to show a picture of the sound source 60.

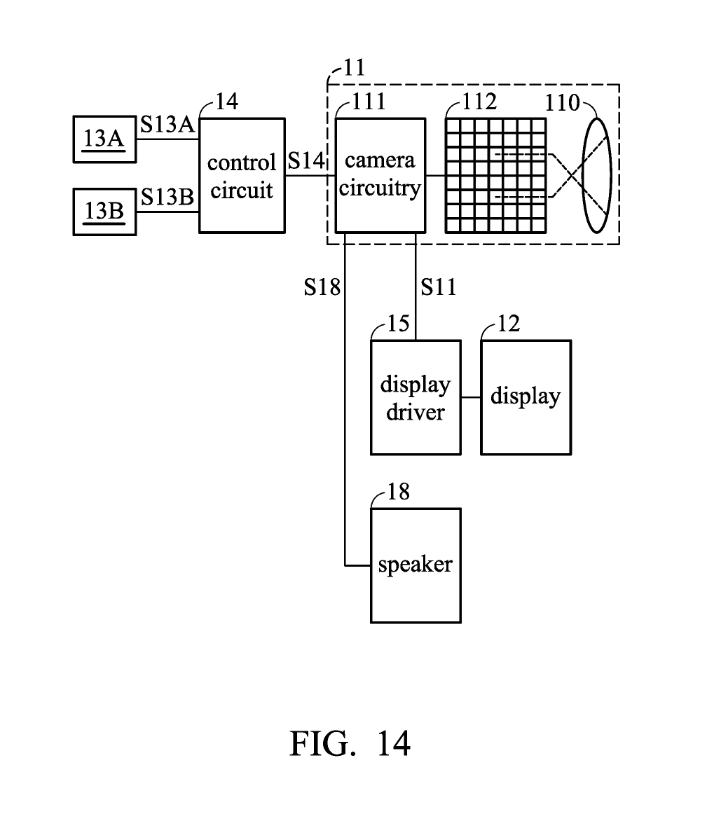

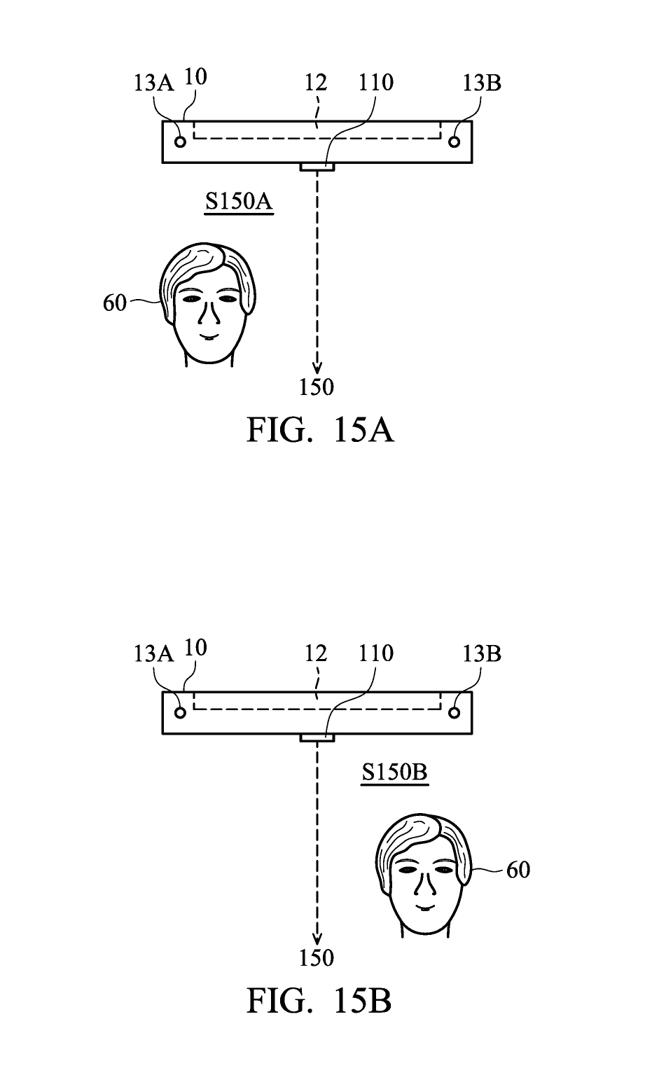

In some embodiment, the electronic device 1 further comprises a speaker. As shown in FIG. 14, a speaker 18 is coupled to the control circuit 14 to receive the control signal S14. As described above, since the control signal S14 is generated according to the result of the direction determination, the camera circuitry 111 can obtain the direction of the location of the sound source 60 according to the control signal S14. The camera circuitry 111 determines whether a central axis of the camera lens 110 aligns with the direction of the location of the sound source 60. When the camera circuitry 111 determines that the central axis of the camera lens 110 does not align with the direction of the location of the sound source 60, the camera circuitry 111 generates a control signal S18 for the speaker 18, and the speaker 18 emits a corresponding sound. For example, as shown in FIG. 15A, when the camera circuitry 111 determines that the central axis 150 of the camera lens 110 does not align with the direction of the location of the sound source 60 and that the direction of the location of the sound source 60 is on a side S150A of the central axis 150, the camera circuitry 111 generates the control signal S18 to enable the speaker 18 to emit a sound with a tone. As shown in FIG. 15B, when the camera circuitry 111 determines that the central axis 150 of the camera lens 110 does not align with the direction of the location of the sound source 60 and that the direction of the location of the sound source 60 is on another side S150B of the central axis 150, the camera circuitry 111 generates the control signal S18 to enable the speaker 18 to emit a sound with another tone. Thus, the speaker 18 is controlled by the control signal S18 derived from the control signal S14 to emit an audible sound which varies depending upon directional alignment with the detected sound. In the embodiment, a user of the electronic device 1 can move or pan the electronic device 1 to make the central axis of the camera lens 110 to align with the direction of the location of the sound source 60.

In the above embodiments, in order to capture a clear and centered image of an object, for example, the user of the electronic device 1, along the determined direction of the location of the sound source 60, the camera circuitry 111 may comprise logic which performs a face detection operation to search a face region of the user. When the logic of the camera circuitry 111 searches a face region of the user, the logic controls the camera 11 to focus the face region on the sensor array 112. Accordingly, the picture of the user can be shown in the display 12 clearly.

According to the embodiments, the electronic device 1 determines the direction of the location of the sound source 60 by detecting the sound from the sound source 60. The electronic device 1 controls the camera 11 according to the determined direction to capture an image of the sound source 60 or an image of the object along the direction of the location of the sound source 60. Thus, when a user of the electronic device 1 emits sounds, the electronic device 1 will takes pictures according to the detected sounds. Particularly, when the user would like to take selfies, the images of the user can be captured by the camera 11 clearly and easily, even though the back camera is used for capturing the image.

According to some embodiments, the electronic device 1 can be a smartphone, digital camera, a table computer, or any other image-capturing device.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device comprising:
a housing;
a camera having a camera lens and camera circuitry, wherein the camera lens is disposed on the housing;
a display disposed on the housing;
at least two sound detectors, spaced apart and disposed at two different locations of the housing, configured to detect an audible sound, and transforming the detected sound into electrical signals; and
a control circuit receiving the electronic signals, the control circuit configured to determine a relative direction of a location of the detected sound and generate a first control signal according to the determined direction.

2. The electronic device as claimed in claim 1 further comprising:
digital pan and zoom circuitry receiving the first control signal,
wherein the digital pan and zoom circuitry is operative to perform a digital pan or digital zoom operation in response to the first control signal,
wherein the digital pan operation causes the camera circuitry to pan toward the determined direction of the detected sound, and
wherein the digital zoom operation causes the camera circuitry to zoom toward the determined direction of the detected sound.

3. The electronic device as claimed in claim 1, wherein the camera circuitry comprises logic that performs a face detection operation to search a face region of an object along the determined direction and controls the camera to focus on the face region.

4. The electronic device as claimed in claim 1, wherein the control circuit comprises command detection circuitry that determines whether the detected sound matches a first predetermined command, wherein when the detected sound matches the first predetermined command, the command detection circuitry generates the first control signal for effecting a zoom or pan operation of the camera.

5. The electronic device as claimed in claim 4 further comprising:
image modifying circuitry configured to receive an image signal which corresponds to an image captured by the camera along the determined direction,
wherein the command detection circuitry determines whether the detected sound matches a second predetermined command, and
wherein when the detected sound is determined to match the second predetermined command, the command detection circuitry generates a second control signal, and the image modifying circuitry modifies the image signal according to the second control signal.

6. The electronic device as claimed in claim 1, wherein the camera comprises:
a motor controlled by the camera circuitry,
wherein the camera circuitry determines a panning angle and controls the motor to pan the camera lens through the panning angle.

7. The electronic device as claimed in claim 1 further comprising a speaker controlled by the first control signal to emit an audible sound which varies depending upon directional alignment with the detected sound.

8. The electronic device as claimed in claim 1, wherein the camera lens is disposed on one side of the housing, and the display is disposed on a side of the housing opposite the camera lens.

9. The electronic device as claimed in claim 1, wherein the camera lens and the display are disposed on the same side of the housing.

10. The electronic device as claimed in claim 1, wherein the at least two sound detectors are disposed in triangular orientation on back face of the housing.

11. The electronic device as claimed in claim 1, wherein the at least two sound detectors are disposed on edges of the housing.

12. The electronic device as claimed in claim 1, wherein the at least two sound detectors are disposed on corners of the housing.

13. The electronic device as claimed in claim 1, wherein the at least two sound detectors are disposed at the two different locations on top face of the housing.

14. The electronic device as claimed in claim 1, wherein the control circuit performs a direction-of-arrival (DOA) estimation operation on the electric signals to determine the direction of the location of the detected sound.

15. An electronic device comprising:
a housing;
a camera having a camera lens and camera circuitry, wherein the camera lens is disposed in the housing;
a display disposed in the housing;
at least two sound detectors, spaced apart and disposed at two different locations of the housing, configured to detect an audible sound, and transforming the detected sound into electrical signals; and
a control circuit receiving the electronic signals, the control circuit configured to determine a relative direction of a location of the detected sound and generate a control signal according to the determined direction,
wherein the camera circuitry pans the camera lens according to the control signal.

16. The electronic device as claimed in claim 15, wherein according to the control signal, the camera pans the camera lens toward the determined direction of the detected sound.

17. The electronic device as claimed in claim 15, wherein the camera comprises:
a motor controlled by the camera circuitry,
wherein the camera circuitry determines a panning angle and controls the motor to pan the camera lens through the panning angle.

18. The electronic device as claimed in claim 15, wherein the camera lens is disposed on one side of the housing, and the display is disposed on a side of the housing opposite the camera lens.

19. The electronic device as claimed in claim 15, wherein the camera lens and the display are disposed on the same side of the housing.

20. The electronic device as claimed in claim 15, wherein the control circuit performs a direction-of-arrival (DOA) estimation operation on the electric signals to determine the direction of the location of the detected sound.
